(19) United States
(12) Patent Application Publication
(10) Pub. No.: US 2025/0188000 A1
(43) Pub. Date: Jun. 12, 2025

(54) NON-THERMAL PLASMA REACTION ASSEMBLY FOR CONTINUOUS AQUEOUS NITROGEN-BASED FERTILIZER PRODUCTION AND METHOD THEREOF

(71) Applicant: University of Tennessee Research Foundation, Knoxville, TN (US)

(72) Inventor: Xiaofei Ye, Knoxville, TN (US)

(21) Appl. No.: 18/973,624

(22) Filed: Dec. 9, 2024

Related U.S. Application Data
(60) Provisional application No. 63/607,884, filed on Dec. 8, 2023.

(51) Int. Cl. C05F 17/979; C05F 17/986

(52) U.S. Cl. CPC C05F 17/979; C05F 17/986

(57) ABSTRACT

A non-thermal plasma reaction assembly continuously produces an aqueous nitrogen-based fertilizer. Atmospheric air or nitrogen gas and water are fed to the non-thermal plasma reaction assembly. One or more coaxial dielectric barrier discharge reactors are provided as part of the non-thermal plasma reaction assembly. The coaxial dielectric barrier discharge reactor(s), per an implementation, has a first plasma discharge zone with a first high-voltage electrode and a second plasma discharge zone with a second high-voltage electrode. The first and second plasma discharge zones and high-voltage electrodes are arranged in succession relative to each other. Compared to past approaches, a higher throughput and higher yield can be furnished with employment of the non-thermal plasma reaction assembly, as well as lower electricity consumption, among many other advancements.

### CROSS-REFERENCE TO RELATED APPLICATION

This application claims the benefit of U.S. Provisional Patent Application No. 63/607,884, with a filing date of Dec. 8, 2023, the contents of which are hereby incorporated by reference in their entirety.

### TECHNICAL FIELD

The present disclosure relates generally to nitrogen-based fertilizer production and, more particularly, to non-thermal plasma reaction assemblies and processes.

### BACKGROUND

Nitrogen-based synthetic fertilizers (N-fertilizers) are in wide use in modern agricultural production for optimizing crop yields. For over a century, mass manufacture of most N-fertilizers has relied on the Haber-Bosch process for producing ammonia. But the process is not without drawbacks and, over time, its production supply chain has shown vulnerabilities, and its consequential carbon dioxide (CO₂) emissions and energy demands have proved unsustainable. Efforts are underway to mitigate these drawbacks by improvements to the Haber-Bosch process itself and through other technologies and innovations in ammonia production. Still, significant challenges in N-fertilizer production remain. Among them, imbalances between throughput and energy efficiency persist, as well as an inability to effect continuous and practical manufacture.

### SUMMARY

In an embodiment, a non-thermal plasma reaction assembly for continuous aqueous nitrogen-based fertilizer production may include a coaxial dielectric barrier discharge reactor. The coaxial dielectric barrier discharge reactor may include a tube housing, a first plasma discharge zone, a second plasma discharge zone, and a ground electrode. The tube housing has one or more inlets and one or more outlets. The first plasma discharge zone resides within an interior of the tube housing and near the inlet(s). The first plasma discharge zone has a first high-voltage electrode situated thereat. The second plasma discharge zone resides within the interior of the tube housing, and resides downstream of the first plasma discharge zone and upstream of the outlet(s). The second plasma discharge zone has a second high-voltage electrode situated thereat. The ground electrode is situated at an exterior of the tube housing. A first electric field is generated at the first plasma discharge zone, and a second electric field is generated at the second plasma discharge zone.

In an embodiment, a method of continuously producing aqueous nitrogen-based fertilizer by way of a non-thermal plasma reaction may include several steps. One step may involve inputting atmospheric air or nitrogen gas, and water, to a first plasma discharge zone. The first plasma discharge zone has a first high-voltage electrode. Another step may involve conveying resultant fluid-flow from the first plasma discharge zone to a second plasma discharge zone. The second plasma discharge zone has a second high-voltage electrode. Yet another step may involve generating a first electric field at the first plasma discharge zone, and generating a second electric field at the second plasma discharge zone.

In an embodiment, a non-thermal plasma reaction assembly for continuous aqueous nitrogen-based fertilizer production may include a coaxial dielectric barrier discharge reactor. The coaxial dielectric barrier discharge reactor may include a tube housing, a first plasma discharge zone, a second plasma discharge zone, an elongated rod, and a ground electrode. The first plasma discharge zone resides within an interior of the tube housing. The first plasma discharge zone has a first high-voltage electrode situated thereat. The first high-voltage electrode has a cylindrical shape with exterior grooves. The second plasma discharge zone resides within the interior of the tube housing, and is located downstream of the first plasma discharge zone. The second plasma discharge zone has a second high-voltage electrode situated thereat. The second plasma discharge zone has an auger shape. The elongated rod extends through the first high-voltage electrode and extends through the second high-voltage electrode. The ground electrode is situated at an exterior of the tube housing. Further, a first discharge gap is defined between the first high-voltage electrode and the ground electrode, and a second discharge gap is defined between the second high-voltage electrode and the ground electrode. And a first electric field is generated at the first discharge gap and a second electric field is generated at the second discharge gap.

Further scope of applicability of the present disclosure will become apparent from the detailed description given hereinafter. But it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given below and the accompanying drawings, which are given by way of illustration only, and do not limit the present disclosure, and wherein:

FIG. 1 depicts an embodiment of a non-thermal plasma reaction assembly;

FIG. 2 depicts an embodiment of a larger irrigation system employing a multitude of non-thermal plasma reaction assemblies;

FIG. 3 is a schematic of an experimental setup utilized in testing performance of an embodiment of a non-thermal plasma reaction assembly;

FIG. 4 depicts another embodiment of the non-thermal plasma reaction assembly;

FIG. 5 is a table presenting test results of embodiments of the non-thermal plasma reaction assembly; and

FIG. 6 is a graph of performance benchmarking of the non-thermal plasma reaction assembly versus past approaches, with specific electricity energy consumption (kWh/mol-N) plotted on an x-axis and production rate of fixed N (micromole-N/hour) plotted on a y-axis.

### DETAILED DESCRIPTION

Referring generally to the drawings, embodiments of a non-thermal plasma reaction assembly 10, as well as of a method involving same, for continuously producing an aqueous nitrogen-based fertilizer (hereafter, N-fertilizer) is depicted and described herein. The non-thermal plasma reaction assembly 10 may also be referred to as a cNTP-H₂O system. In various embodiments, the non-thermal plasma reaction assembly 10 is equipped with one or multiple coaxial dielectric barrier discharge reactors. Unlike past approaches, per certain embodiments the sole inputs and feedstock can be atmospheric air or nitrogen gas, and water, that traverse over two plasma discharge zones in succession. An aqueous nitrogen-based fertilizer—primarily in the form of nitrate (NO₃⁻), nitrite (NO₂⁻), and ammonium (NH₄⁺)—is provided in a continuous and water-flow-through manner via employment of the non-thermal plasma reaction assembly 10. A relatively higher throughput and yield, and lower electricity consumption, is furnished compared to past approaches, as well as on-site and on-demand production capabilities.

Moreover, the non-thermal plasma reaction assembly 10 is adaptive to potentially intermittent solar and/or wind electricity supply (i.e., can be readily switched on and off); possesses a modular and scalable design and construction; can be readily and practically integrated, retrofitted, and equipped in an irrigation system; and emits no carbon dioxide (CO₂). The need for the extensive capital investment and infrastructure of the past nitrogen-based synthetic fertilizer production and storage approaches, often accompanied by complex and costly distribution networks, is circumvented via utilization of the non-thermal plasma reaction assembly 10 and method. Yet further, the non-thermal plasma reaction assembly 10, in addition to its N-fertilizer production capabilities, may neutralize certain bacteria such as E-coli, pesticides, and potentially other substances. Still, a particular embodiment of the non-thermal plasma reaction assembly 10 and method may exhibit only one, or a combination of, the advancements set forth herein, none of the advancements, or other advancements that go unmentioned. Furthermore, as used herein, the terms downstream and upstream are used with reference to the general direction of the flow of fluids through the non-thermal plasma reaction assembly 10 from entry to exit, where downstream denotes forward advancement of the fluid therethrough and upstream denotes a direction that is opposite that of downstream.

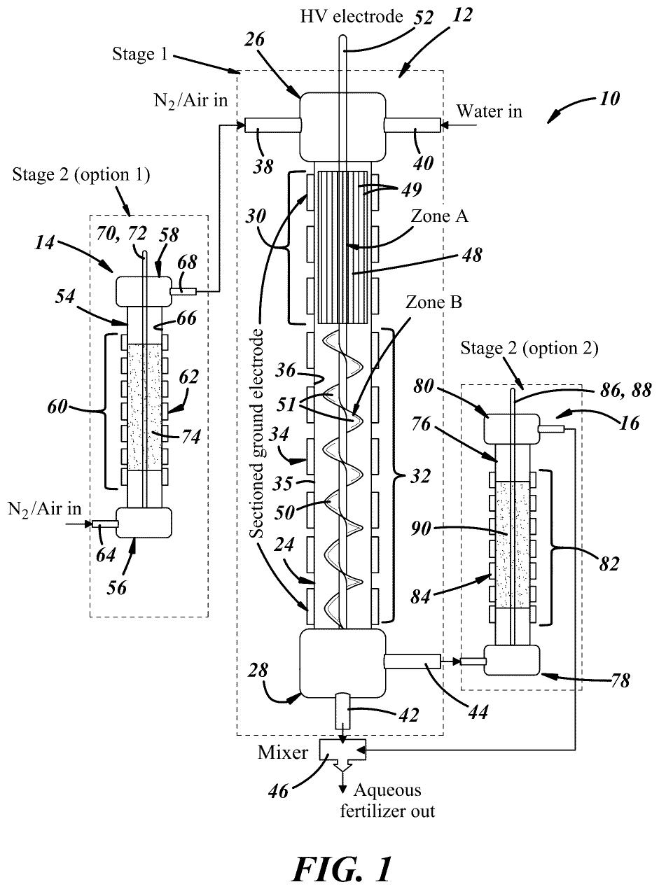

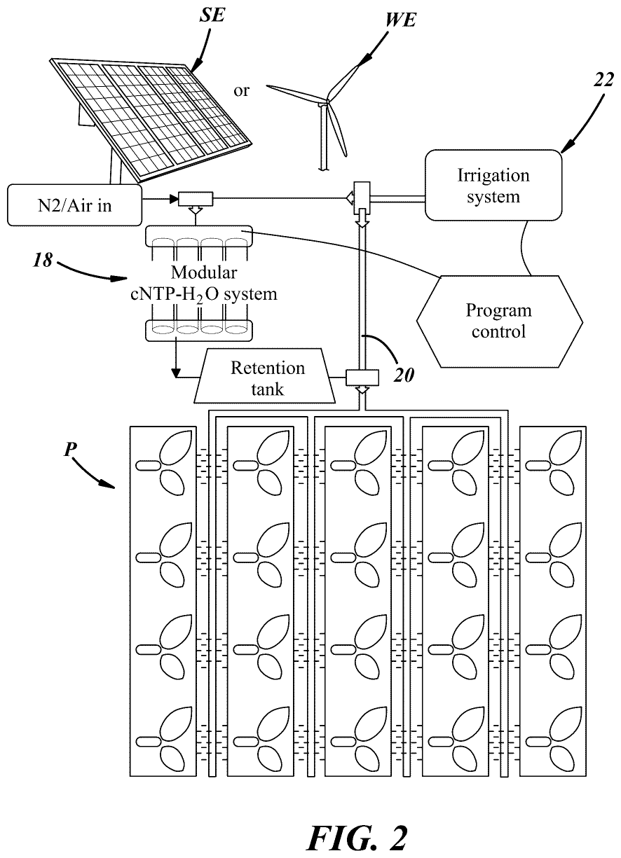

With reference to FIG. 1, the non-thermal plasma reaction assembly 10 can exhibit various designs, constructions, and components in various embodiments depending upon—among other potential factors—the desired N-fertilizer yield and constituents ultimately produced. In the embodiment of the figures, the non-thermal plasma reaction assembly 10 includes a primary, or first, coaxial dielectric barrier discharge (DBD) reactor 12; can include a secondary, or second, coaxial dielectric barrier discharge (DBD) reactor 14; and can include a secondary, or third, coaxial dielectric barrier discharge (DBD) reactor 16. The non-thermal plasma reaction assembly 10 is presented as a modular unit cell in FIG. 1 that can be combined with numerous additional unit cells similarly constructed to establish a larger non-thermal plasma reaction system and installation 18 (FIG. 2) for increased N-fertilizer production for application amid agricultural production and to plants P. The non-thermal plasma reaction assemblies 10 that make-up the non-thermal plasma reaction system 18 can be bundled and connected together in a parallel arrangement and configuration, according to an embodiment. The non-thermal plasma reaction system 18 can be retrofitted and installed in existing irrigation lines 20 and existing irrigation systems 22, or can be part of the original equipment and original installation. Renewable electricity sources that are often intermittent in nature, such as solar electricity SE and/or wind electricity WE can be more readily employed as a source of electricity for the non-thermal plasma reaction assemblies 10 and non-thermal plasma reaction system 18 as a result of the ready activation and deactivation capabilities (i.e., on and off states) of the assemblies and system.

The first coaxial DBD reactor 12 can constitute a first stage of the non-thermal plasma reaction assembly 10, and can itself exhibit various designs, constructions, and components in various embodiments. In the embodiment of FIG. 1, as its main components, the first coaxial DBD reactor 12 includes a tube housing 24, an inlet cover 26, an outlet cover 28, a first plasma discharge zone 30, a second plasma discharge zone 32, and a ground electrode 34. The synthesis reaction that produces the N-fertilizer occurs within the tube housing 24. The tube housing 24 houses the first and second plasma discharge zones 30, 32 at its interior 36, and accepts securement of the inlet cover 26 at a top end and of the outlet cover 28 at a bottom end. The inlet and outlet covers 26, 28 are hermetically sealed at the respective top and bottom ends. In an example embodiment, the tube housing 24 is a quartz tube possessing an outer diameter of approximately twenty-three millimeters (23 mm), an inner diameter of approximately twenty millimeters (20 mm), and a longitudinal length of approximately four-hundred-and-six millimeters (406 mm); still, in other example embodiments, other material constructions and diameter and length dimensions are contemplated. The tube housing 24 serves as the dielectric barrier of the first coaxial DBD reactor 12.

The inlet cover 26, per this embodiment, has a first inlet 38 and a second inlet 40. The first inlet 38 receives atmospheric air, nitrogen gas (N₂), or a mixture of both amid use of the first coaxial DBD reactor 12, and the second inlet 40 receives water amid use. The atmospheric air, nitrogen gas (N₂), or mixture thereof and water can be at atmospheric pressure as they traverse the inlet cover 26, and are delivered to the interior 36 and to the first and second plasma discharge zones 30, 32 via the inlet cover 26. According to this embodiment, the atmospheric air, nitrogen gas (N₂), or mixture thereof and water constitute the sole feedstock of the first coaxial DBD reactor 12 utilized for the subsequent production of N-fertilizer. The outlet cover 28 is located opposite the inlet cover 26 relative to the tube housing 24, as illustrated in FIG. 1. In an embodiment that lacks the third coaxial DBD reactor 16, the outlet cover 28 can have a single outlet 42. In an embodiment that includes the third coaxial DBD reactor 16, on the other hand, the outlet cover 28 can have a second outlet 44 in addition to the first outlet 42. Resultant N-fertilizer exits the outlet 42 via gravity, where it can be collected. At the outlet 42, the N-fertilizer can be in aqueous and liquid-stream form. Further, a mixer 46 can be provided downstream of the outlet cover 28, per an embodiment. The inlet and outlet covers 26, 28 can be composed of a plastic material such as acrylonitrile butadiene styrene (ABS), or can be composed of another type of material that exhibits suitable electrical insulation properties and that can endure temperatures of approximately one-hundred degrees Celsius (100° C.), per various applications and embodiments.

The first plasma discharge zone 30 initially receives the atmospheric air, nitrogen gas (N₂), or mixture thereof and water upon entrance and introduction into the first coaxial DBD reactor 12, per an embodiment. The first plasma discharge zone 30 resides within the interior 36 of the tube housing 24 and is situated immediately downstream of the inlet cover 26 and of the first and second inlets 38, 40. The first plasma discharge zone 30 is situated immediately upstream of the second plasma discharge zone 32. A first longitudinal length and extent of the first plasma discharge zone 30 is less than a second longitudinal length and extent of the second plasma discharge zone 32, according to the embodiment of FIG. 1; still, in another embodiment the first longitudinal length and extent of the first plasma discharge zone 30 can be greater than the second longitudinal length and extent of the second plasma discharge zone 32.

In this embodiment, the first plasma discharge zone 30 has a first high-voltage (HV) electrode 48 as part of its establishment. The first HV electrode 48 can exhibit various designs, constructions, and components in various embodiments. In FIG. 1, the first HV electrode 48 has a cylindrical shape with a multitude of exterior grooves 49 and is composed of a metal material such as an aluminum material. The cylindrical shape complements the shape of the tube housing 24. The exterior grooves 49 are arranged longitudinally and axially with respect to the tube housing 24. The exterior grooves 49 can be situated around the circumference of the first HV electrode 48. Water is channeled downstream and downward over the exterior grooves 49 as it makes its way through the first plasma discharge zone 30. In an example embodiment, this grooved aluminum cylinder possesses an outer diameter of approximately eighteen millimeters (18 mm) and a longitudinal length of approximately one-hundred millimeters (100 mm); still, in other example embodiments, other material constructions such as other electrically conductive materials and other diameter and length dimensions are contemplated. Further, a first discharge gap is defined between an outermost surface of the first HV electrode 48 and an inner surface of the tube housing 24. Compared to that of the second plasma discharge zone 32, the first discharge gap has a smaller dimension; still, in another embodiment the first discharge gap can have a larger dimension than that at the second plasma discharge zone 32. In an example embodiment, the first discharge gap possesses a dimension of approximately one millimeter (1 mm); still, in other example embodiments, other discharge gap dimensions are contemplated. Across the first discharge gap, the first HV electrode 48 generates a first electric field during use of the first coaxial DBD reactor 12 and amid use of the non-thermal plasma reaction assembly 10. The first electric field, per this embodiment, has a magnitude that is relatively stronger and greater than that generated by the second plasma discharge zone 32; still, in another embodiment the first electric field can have a magnitude that is relatively weaker and less than that generated at the second plasma discharge zone 32. Moreover, in experiments conducted, as set forth below, volumetric diffuse plasma at atmospheric pressure was visually observed in the first plasma discharge zone 30. In yet other alternative embodiments, a catalyst material composition can be provided at the first HV electrode 48 in order to facilitate the reaction that occurs thereat; when provided, the catalyst material composition can take various forms including via a coating or embedment or some other way, and can include one or more platinum, palladium, ruthenium, nickel, iron, and a manganese oxide compound supported on a dielectric carrier, among other possibilities.

The second plasma discharge zone 32 receives resultant fluid-flow from the first plasma discharge zone 30. Like the first plasma discharge zone 30, the second plasma discharge zone 32 resides within the interior 36 of the tube housing 24, and is situated immediately downstream of the first plasma discharge zone 30. The second plasma discharge zone 32 is situated immediately upstream of the outlet cover 28. In this embodiment, the second plasma discharge zone 32 has a second high-voltage (HV) electrode 50 as part of its establishment. The second HV electrode 50 can exhibit various designs, constructions, and components in various embodiments. In FIG. 1, the second HV electrode 50 has an auger shape and is composed of a metal material such as an aluminum material or a stainless-steel material. More specific example material compositions can include the aluminum alloy AlSi10Mg, and the stainless steel SS316; still, other material compositions are contemplated, including other aluminum and stainless steel compositions, as well as other types of metal compositions. The auger shape can be a triple-helical auger shape, per an embodiment, or could be a single-, double- or quadruple-helical auger shape, as examples. Water flows downstream and downward in a spiral path over a blade 51 of the auger shape as the water makes its way through the second plasma discharge zone 32. It has been found that the auger shape and its spiraling blade 52, in particular, serves to augment and enhance production of N-fertilizer, per this embodiment; still, other shapes are possible in other embodiments. It is currently believed that the augmentation and enhancement of N-fertilizer production facilitated by the auger shape is due at least in part to one or more of the following: i) the distribution of electric field strength due to the auger shape, ii) water flow and continuous process capabilities provided by the auger shape, and/or iii) the spiral flow enabled by the auger shape increases residence time of the reactants, enhances water-gas interfacial reactions, and facilitates mixing and absorption and mass transfer that enhance the aqueous N-fertilizer production; still, other and/or different theories of causation and rationales for its facilitation are indeed possible.

In an example embodiment, the auger-shaped second HV electrode 50 possesses an outer diameter of approximately seventeen and a half millimeters (17.5 mm) and a longitudinal length of approximately two-hundred and twenty millimeters (220 mm); still, in other example embodiments, other material constructions and other diameter and length dimensions are contemplated. The longitudinal length of the second HV electrode 50, per this example embodiment, is more than twice the longitudinal length of the first HV electrode 48; still, other relative lengths are contemplated in other example embodiments. Further, a second discharge gap is defined between an outermost edge of the second HV electrode 50 and the inner surface of the tube housing 24. Compared to the first discharge gap of the first HV electrode 48, the second discharge gap has a larger dimension. In an example embodiment, the second discharge gap possesses a dimension of approximately one and a quarter millimeter (1.25 mm); still, in other example embodiments, other discharge gap dimensions are contemplated. Across the second discharge gap, the second HV electrode 50 generates a second electric field during use of the first coaxial DBD reactor 12. The second electric field, per this embodiment, has a magnitude that is relatively weaker and less than that generated by the first plasma discharge zone 30. The relatively weaker second electric field of the larger spiral-shaped second discharge gap of the second HV electrode 50 furnishes a reduced electricity consumption while maintaining excited plasma species to facilitate and promote chemical reactions. Moreover, it has been shown that all reactants traversing through the second plasma discharge zone 32 experience a distribution of electric field and non-thermal plasma treatment that is similar to repeating a gliding arc plasma discharge. Moreover, in experiments conducted, as set forth below, a mixed diffuse and filament discharge was visually observed in the second plasma discharge zone 32. In yet other alternative embodiments, a catalyst material composition can be provided at the second HV electrode 50 in order to facilitate the reaction that occurs thereat; when provided, the catalyst material composition can take various forms including via a coating or embedment or some other way, and can include one or more platinum, palladium, ruthenium, nickel, iron, and a manganese oxide compound supported on a dielectric carrier, among other possibilities.

The ground electrode 34 serves to facilitate establishment of the first and second electric fields of the first and second plasma discharge zones 30, 32. The ground electrode 34 can exhibit various designs, constructions, and components in various embodiments. In FIG. 1, the ground electrode 34 is in the form of sectioned tape wrapped around an outer surface 35 of the tube housing 24 and at an exterior of the tube housing 24. In an example embodiment, the tape possesses a thickness dimension of approximately 0.79 mm and can be composed of a copper material or an aluminum material; still, in other example embodiments, other thickness dimensions and other material constructions are contemplated.

Further, according to this embodiment, the first coaxial DBD reactor 12 includes an elongated rod 52 that extends through both the first HV electrode 48 and the second HV electrode 50. The elongated rod 52 further extends through the inlet cover 26 for connection with a high voltage source. The first and second HV electrodes 48, 50, as well as the inlet cover 26, have openings residing therein for reception of the elongated rod 52, per this embodiment. The reception and fit thereamong provides a relatively tight surface-to-surface contact. In an example embodiment, the elongated rod 52 is composed of a metal material such as a stainless-steel material and possesses an outer diameter of approximately four millimeters (4 mm); still, in other example embodiments, other material constructions and other diameter dimensions are contemplated.

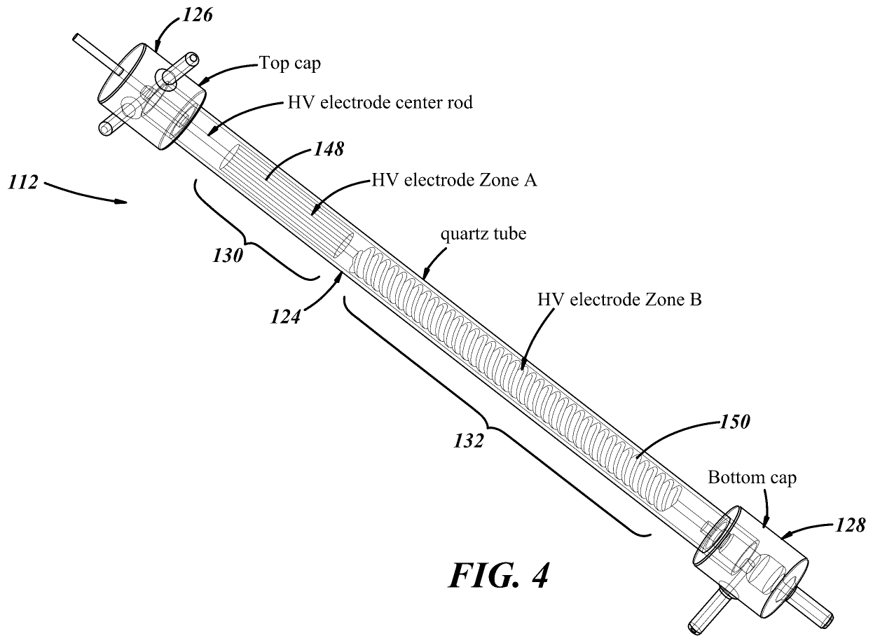

Turning now to FIG. 4, a second embodiment of the first coaxial DBD reactor is presented. In the second embodiment, certain corresponding components and elements are numbered similarly but with numerals 1xx when referring to this second embodiment. For example, the first coaxial DBD reactor is referenced by numeral 12 in the first embodiment, and is correspondingly referenced by numeral 112 in the second embodiment. Moreover, many similarities exist between the first embodiment and the second embodiment, some of which may not be repeated here in the description of the second embodiment. At least certain appreciable differences between the embodiments are described. In FIG. 4, the first coaxial DBD reactor 112 includes a tube housing 124, an inlet cover 126, an outlet cover 128, a first plasma discharge zone 130, a second plasma discharge zone 132, and a ground electrode (not shown). The first plasma discharge zone 130 has a first HV electrode 148. The first HV electrode 148 has a cylindrical shape with a multitude of exterior grooves. The second plasma discharge zone 132 has a second HV electrode 150. The second HV electrode 150 has a triple-helical auger shape, according to the second embodiment. The triple-helical auger shape, it is thought, facilitates reactions that take place at the second plasma discharge zone 132.

In use, according to an embodiment, the non-thermal plasma reaction assembly 10 serves to produce an aqueous nitrogen-based fertilizer. The aqueous nitrogen-based fertilizer can be in the form of one or more of nitrate, nitrite, and/or ammonium, per various embodiments. The nitrite can be in trace amounts. The production ratio of nitrate/nitrite/ammonium of the aqueous nitrogen-based fertilizer can be tuned according to—among other possible factors—the growth stages of the particular agricultural production and plants P, as an example. The produced aqueous nitrogen-based fertilizer has proven suitable for direct application to the agricultural production and plants P, such as crops and vegetables, without the necessity of the past that involved downstream separations and/or additional processes. Further, although nitrogen oxidation is thermodynamically favored relative to nitrogen reduction at atmospheric pressure and near ambient temperature, it has been shown that both oxidation and reduction pathways exist at the interface between a nitrogen plasma and water surface, resulting in the production of both NOx and ammonium. But most highly reactive plasma species exhibit a very short half-life on the order of a few nanoseconds to a few milliseconds. Accordingly, it has been determined that, per at least certain embodiments, it can be suitable to consider not only the generation of such reactive species, but also their efficient delivery into liquid products.

In the non-thermal plasma reaction assembly 10, both water and air concurrently flow through the first and second plasma discharge zones 30, 32, serving to intensify interfacial reactions to enhance mass transfer and tune the production of fixed nitrogen in a continuous fashion. In addition to common reactive oxygen and nitrogen species (RONS) generated in air plasma, the presence of water in the plasma of the non-thermal plasma reaction assembly 10 has been shown to also generate solvated electrons, hydrogen radicals (H.), hydroxyl radicals (.OH), perhydroxyl radicals (HOO.), and hydrogen peroxide (H₂O₂), which are among the strongest reduction or oxidation agents for nitrogen fixation. The presence of water, it has been found, helps quench the RONS produced by non-thermal plasma, rapidly converting them into more stable nitrogen-containing compounds. This quenching effect facilitates prevention of the back reactions of RONS. Water also serves as an absorption medium in situ for the fixed nitrogen, effectively removing it from the gas phase where back reactions are more likely to occur, shifting the equilibrium toward the formation of desired product. Furthermore, in the non-thermal plasma reaction assembly 10, the first and second plasma discharge zones 30, 32 reside in a single unit-cell, providing efficient utilization of applied power and reduced energy consumption. As an example, per an embodiment, the generation of RONS and reactive hydrogen species can be enhanced as the glow discharge acts as an excitation pre-treatment in the first plasma discharge zone 30 prior to filament discharge in the second plasma discharge zone 32. Turbulent flows of air and water transiently pass through the first and second plasma discharge zones 30, 32, undergoing intensified contact and mixing, while the produced NOx and ammonium are absorbed by water in situ, further driving reactions toward a higher yield of fixed nitrogen. Moreover, because of the strong oxidants, such as .O., O₂⁻., .OH, HOO., O₃, and H₂O₂ generated in the water-air plasma spanning a long range of half-lives, the non-thermal plasma reaction assembly 10, per an embodiment, produces nitrate (NO₃⁻) as the major product, which is the preferred form of nitrogen taken up by plants.

With reference again to FIG. 1, when provided in an embodiment, the second coaxial DBD reactor 14 can constitute a second stage of the non-thermal plasma reaction assembly 10, and can itself exhibit various designs, constructions, and components in various embodiments. With respect to the first coaxial DBD reactor 12, the second coaxial DBD reactor 14 has an upstream position and location. The second coaxial DBD reactor 14 is situated in-line with the first coaxial DBD reactor 12. In the embodiment of FIG. 1, the second coaxial DBD reactor 14 resembles the first coaxial DBD reactor 12 in certain regards, but is smaller in overall size. As its main components, the second coaxial DBD reactor 14 includes a tube housing 54, an inlet cover 56, an outlet cover 58, a plasma discharge zone 60, and a ground electrode 62. In an example embodiment, the tube housing 54 is a quartz tube possessing an outer diameter of approximately twenty-three millimeters (23 mm), an inner diameter of approximately twenty millimeters (20 mm), and a longitudinal length of approximately three-hundred-and-five millimeters (305 mm); still, in other example embodiments, other material constructions and diameter and length dimensions are contemplated. The inlet cover 56, per this embodiment, has a single inlet 64 that receives the atmospheric air, nitrogen gas (N₂), or mixture thereof, and delivers it to an interior 66 of the tube housing 54. After traversing through the second coaxial DBD reactor 14—and after reactions occur therein—resultant fluid-flow is delivered to the first inlet 38 of the first coaxial DBD reactor 12 for mixing with water and further reactions downstream thereof. A single outlet 68 of the outlet cover 58 fluidly communicates with the first inlet 38.

The plasma discharge zone 60 has a high-voltage (HV) electrode 70 in the form of an elongated rod 72 (also called a high-voltage rod electrode) extending through the interior 66 of the tube housing 54 between the inlet and outlet covers 56, 58. In an example embodiment, the elongated rod 72 is composed of a stainless-steel material; still, in other example embodiments, other material constructions are contemplated. Further, according to this embodiment, the plasma discharge zone 60 includes a multitude of beads 74 residing and packed within the interior 66 of the tube housing 54. The beads 74 can be cylindrical, can be in the form of pellets, or can exhibit some other shape and formation. In various embodiments, the beads 74 can be composed of a dielectric material, a catalyst material, or a combination of both in which some of the beads 74 are composed of a dielectric material and some are composed of a catalyst material. Examples of dielectric materials include, but are not limited to, silica, alumina, zirconia, titanium, dioxide, and barium titanate of differing permittivity. Examples of catalyst materials include, but are not limited to, platinum, palladium, ruthenium, nickel, iron, and a manganese oxide compound supported on a carrier composed of silica, alumina, or zirconia. In an example embodiment, a volume of approximately twenty-five milliliters (25 mL) of beads 74 is packed within the tube housing's interior 66 and the beads 74 possess an outer diameter that ranges approximately between one and three millimeters (1-3 mm); still, other example embodiments, other volumes and diameter dimensions are contemplated. Lastly, the ground electrode 62 in this embodiment is in the form of sectioned tape wrapped around an outer surface of the tube housing 54. In an example embodiment, the tape possesses a thickness dimension of approximately 0.79 mm and can be composed of a copper material or an aluminum material; still, in other example embodiments, other thickness dimensions and other material constructions are contemplated.

It has been shown that employment of the second coaxial DBD reactor 14 can serve to measurably increase atomic nitrogen production—depending upon certain circumstances such as the dielectric constant of the beads 74 used—and can reduce overall electricity consumption and facilitate production capacity of nitrogen oxides (i.e., NOₓ, mainly composed of NO₂ and NO) of the non-thermal plasma reaction assembly 10.

When provided in an embodiment, the third coaxial DBD reactor 16 can constitute a second stage of the non-thermal plasma reaction assembly 10, and can itself exhibit various designs, constructions, and components in various embodiments. With respect to the first coaxial DBD reactor 12, the third coaxial DBD reactor 16 has a downstream position and location. In differing embodiments, the third coaxial DBD reactor 16 can be provided alone and without the second coaxial DBD reactor 14, or the third coaxial DBD reactor 16 can be provided in addition to the second coaxial DBD reactor 14. The third coaxial DBD reactor 16 is situated in-line with the first coaxial DBD reactor 12. In the embodiment of FIG. 1, the third coaxial DBD reactor 16 resembles the second coaxial DBD reactor 14. Accordingly, as before, the third coaxial DBD reactor 16 includes a tube housing 76, an inlet cover 78, an outlet cover 80, a plasma discharge zone 82, and a ground electrode 84. The plasma discharge zone 82 has a high-voltage (HV) electrode 86 in the form of an elongated rod 88 (also called a high-voltage rod electrode) extending through the tube housing 76, and includes a multitude of dielectric and/or catalyst beads 90 residing and packed within the tube housing 76. With use of the third coaxial DBD reactor 16, separated gaseous resultant of the first coaxial DBD reactor 12 travels to the third coaxial DBD reactor 16 via the second outlet 44 where further reactions take place. Resultant effluent exits the third coaxial DBD reactor 16 and is delivered for mixing with the liquid stream of the outlet 42.

Whether use of the second and/or third coaxial DBD reactor 14, 16 is employed may be dictated by the desired composition of the N-fertilizer. For instance, a reduction palladium catalyst material for the beads 90 of the third coaxial DBD reactor 16 can be utilized in order to convert nitric oxide (NO) and H₂ produced in the first coaxial DBD reactor 12 to NH₃. Or an oxidation catalyst could serve to further oxidize NO to NO₂ with residual O₂ in the input air. Sill, many other modifications are possible.

Furthermore, the non-thermal plasma reaction assembly 10 and its assemblies and components, as described, are configurable and tunable in various embodiments for adjustments to the desired N-fertilizer yield and adjustments to the desired production rate, the desired constituents and compositions of the nitrate and nitrite and ammonium ultimately produced, and the desired electricity consumption. Modifications are contemplated for optimizing and maximizing yields and production rates and minimizing associated energy costs for various applications. In examples, such adjustments and modifications can be effected via changes to one or more of the following: chemistry and plasma kinetics; relative position and location of the first and second plasma discharge zones 30, 32; provision of one or more plasma discharge zones in addition to the first and second plasma discharge zones 30, 32; shape and geometry of the first and second HV electrodes 48, 50; relative dimensions of the first and second discharge gaps; relative strength and/or weakness provided for the first and second electric fields; diameter and length and other dimensions of the first and second HV electrodes 48, 50; material compositions of the first and second HV electrodes 48, 50 and ground electrode 34; dimensions and spacings of the ground electrode 34; and/or the provision of a catalyst material such as via embedding and/or coating to one or more of the HV electrodes set forth herein. Such changes could also be made to the second and/or third coaxial DBD reactors 14, 16 in embodiments in which they are provided, including changes to the material compositions and sizes and shapes of the accompanying beads. Still, changes to other parameters of other assemblies and components in the non-thermal plasma reaction assembly 10 are possible.

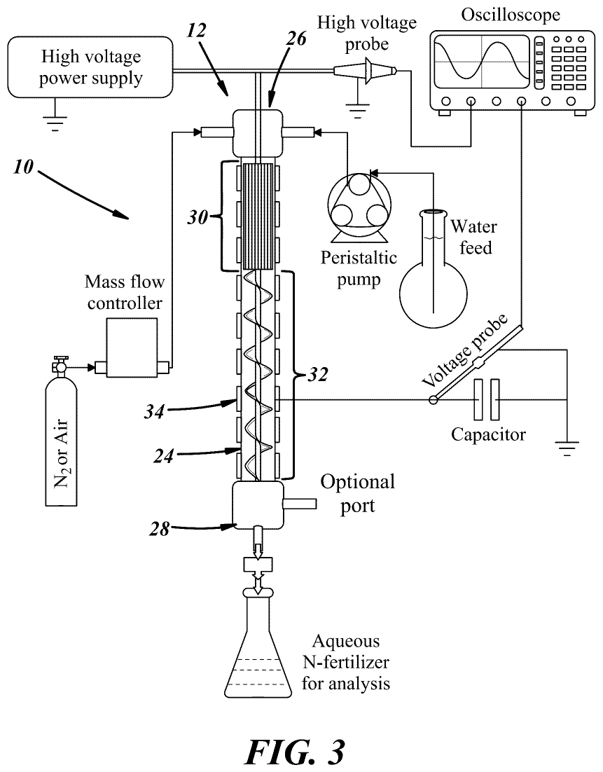

With reference to FIG. 3, a schematic of an experimental setup for testing the performance of an embodiment of the non-thermal plasma reaction assembly 10 (i.e., cNTP-H2O system) is presented. A mass flow controller and a peristaltic pump was used to continuously meter N₂ (Industrial Grade) or air and water into the cNTP-H2O system, respectively. Distilled water or tap water was used in the tests, while other water sources, such as irrigation water or reclaimed wastewater could be potentially used, because of the recorded sanitary benefits of nonthermal plasma on microbials and contaminates. Different configurations of the cNTP-H2O system were tested and reported in this disclosure.

To power up the accompanying Stage-1 DBD reactor, AC sinusoidal waveform was generated by an inverter (PTI, Racine, WI) followed with amplification by a voltage transformer (PTI, Racine, WI). The waveform of the DBD discharge was monitored via an oscilloscope (WaveJet™ series, LeCroy, Chestnut Ridge, NY). The tunable inverter together with the oscilloscope allowed the adjustment of the output voltage to a desired value (between 6 and 30 kV pk-pk) and the resonance frequency of the capacitive reactor load (at ˜21 kHz in this demonstration). A capacitor (2 μF) was inserted in the circuit to create a phase lag to generate Lissajous parallelogram for the calculation of DBD discharge power, which is a common method for the measurement of plasma discharge power. In case a Stage-2 DBD reactor was needed, a second power supply of the same type was used to power the Stage-2. The Stage-2 power consumption was maintained stable around 20 W, while the power consumption by Stage-1 varied greatly (between approximately 50-180 W), depending on the applied high voltage and reactor configurations. Other types of power supplies could also be used to power the cNTP-H₂O system. However, if AC is used, it is ideal to be supplied at the resonance frequency of the capacitive reactor load, in order to achieve high energy efficiency. The design of electrical power supply for the cNTP-H2O system could be subject to future research that may further improve performance and energy efficiency. For example, nanosecond-pulsed high-voltage has the potential to reduce plasma energy consumption, but this kind of power supply can be generally more expensive.

Aqueous N-fertilizer exiting the cNTP-H2O system was collected in a flask for the analysis of the fixed nitrogen concentration in the forms of NO₃⁻, NO₂⁻, and NH₄⁺, according to EPA methods 353.2 and 350.1, using colorimetry performed on a spectrophotometer (Genesys 10S, ThermoFisher Scientific, USA). The nitrite was determined by diazotizing with sulfanilamide and coupling with N-(1-naphthy)ethylenediamine dihydrochloride to form a highly colored azo dye which was measured at 540 nm. For nitrate analysis, the sample was first passed through a column containing granulated copper-cadmium to reduce the nitrate to nitrite to be analyzed as previously described. The difference in concentration (mg-N/L) between the total nitrite (originally present plus that reduced from nitrate) and the original nitrite was reported as nitrate concentration. The procedure for the determination of ammonium is based on the modified Berthelot reaction; alkaline phenol and hypochlorite react with ammonium to form indophenol blue that is proportional to the ammonium concentration. The blue color formed was intensified with sodium nitroprusside, and measured at 660 nm.

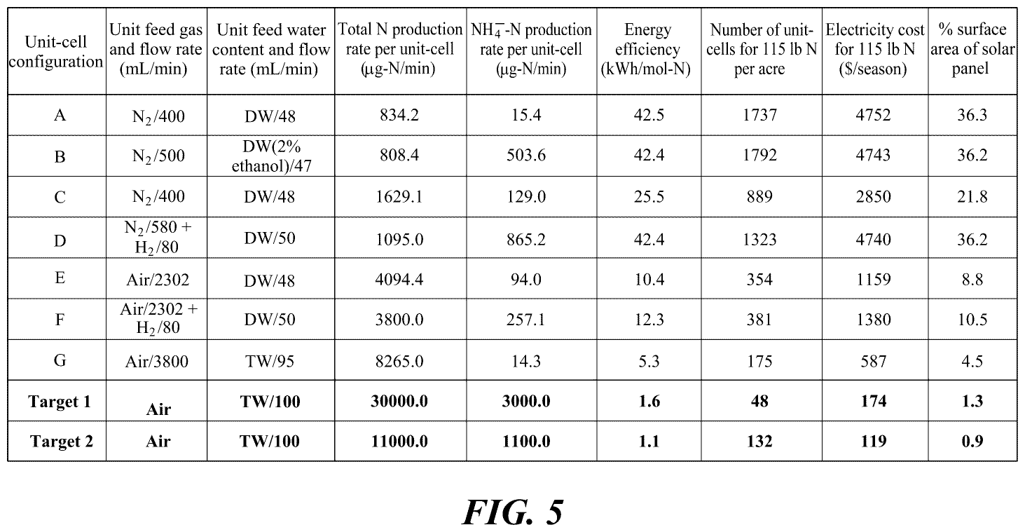

Different configurations of the cNTP-H₂O system were tested and certain results are summarized in the table of FIG. 5, which also includes preliminary economic estimations. The table shows the significant progress of improving the energy efficiency and production rate of fixed nitrogen by configuring the cNTP-H₂O system and operation parameters. Unit-cell configuration A was a one stage, one zone configuration; the one zone resembled the auger-shaped HV electrode described herein, and was composed of an SS316 material. Unit-cell configuration B was a one stage, two zone configuration; the two zones resembled the cylindrically-shaped and exteriorly-grooved HV electrode described herein, and the auger-shaped HV electrode described herein; both HV electrodes were composed of an SS316 material. Unit-cell configuration C was a two stage, two zone configuration; the two zones resembled the cylindrically-shaped and exteriorly-grooved HV electrode described herein, and the auger-shaped HV electrode described herein; both HV electrodes were composed of an SS316 material; further, the second stage resembled the second and third coaxial DBD reactors described herein and had a palladium catalyst supported on mesoporous silica. Unit-cell configuration D was a two stage, two zone configuration; the two zones resembled the cylindrically-shaped and exteriorly-grooved HV electrode described herein, and the auger-shaped HV electrode described herein; both HV electrodes were composed of an SS316 material; further, the second stage resembled the second and third coaxial DBD reactors described herein and had a palladium catalyst supported on mesoporous silica. Unit-cell configuration E was a two stage, two zone configuration; the two zones resembled the cylindrically-shaped and exteriorly-grooved HV electrode described herein, and the auger-shaped HV electrode described herein; both HV electrodes were composed of an SS316 material; further, the second stage resembled the second and third coaxial DBD reactors described herein and had a palladium catalyst supported on mesoporous silica. Unit-cell configuration F was a two stage, two zone configuration; the two zones resembled the cylindrically-shaped and exteriorly-grooved HV electrode described herein, and the auger-shaped HV electrode described herein; both HV electrodes were composed of an SS316 material; further, the second stage resembled the second and third coaxial DBD reactors described herein and had a palladium catalyst supported on mesoporous silica. Lastly, unit-cell configuration G was a two stage, two zone configuration; the two zones resembled the cylindrically-shaped and exteriorly-grooved HV electrode described herein, and the auger-shaped HV electrode described herein; both HV electrodes were composed of an AlSi10Mg material; further, the second stage resembled the second and third coaxial DBD reactors described herein and had a manganese oxide catalyst supported on mesoporous alumina.

Furthermore, in the table of FIG. 5, for the heading “Unit feed gas and flow rate,” the feed gas was either pure nitrogen, air (79% nitrogen, 21% oxygen), or air/nitrogen plus (+) hydrogen gas with flow rate indicated. For the heading “Unit feed water content and flow rate,” the feed water was either distilled water (DW), tap water (TW), or DW added with 2% ethanol. For the heading “Total N Production rate per unit-cell,” the number indicates the summation of measured NO₃⁻, NO₂⁻ and NH₄⁺ in the aqueous N-fertilizer. For the heading “Energy efficiency,” this is based on the production of total fixed nitrogen, including NO₃⁻, NO₂⁻, and NH₄⁺, and the measurement of NTP power consumption using Lissajous parallelogram method. For the heading “Number of unit-cells for 115 lb N per acre,” this is calculated practically assuming that the reaction system is powered by intermittent solar or wind electricity for a typical crop growing season of 600 h (6 h per day for 100 days). It is aimed, per an embodiment, to demonstrate the economic feasibility of replacing the use of synthetic N-fertilizer at an ideal rate of 115 lb-N per acre per season for corn production, which can be considered the most demanding agricultural practice for N-fertilizer. Nationally, the weighted average of corn N inputs (188 kg-N per hectare) based on corn-planted area exceeded N needs (115 lb-N per acre) by 60 kg-N per hectare, with N surplus found in 80% of all U.S. corn-producing counties. For the heading “Electricity cost for 115 lb N,” this is calculated assuming that levelized cost of renewable electricity is $0.03/KWh. The levelized cost of electricity (LCOE) is a measure of the average net present cost of electricity generation for a generator over its lifetime. It is used for investment planning and to compare different methods of electricity generation on a consistent basis. It can include the cost of capital, decommissioning, fuel costs, fixed and variable operations and maintenance costs, financing costs, and an assumed utilization rate. In the year 2020, as an example, the LCOE of utility-scale solar and wind reached down to $0.03/KWh, and further decline in the future is forecasted. For the heading “% surface area of solar panel,” using installed solar panels as example, the number gives a visual estimation of the panel surface area for providing 115 lb-N/acre. The footprint of the corresponding cNTP-H₂O system is much smaller and can easily fit under the solar panels. The area occupied by solar panels is estimated based on the total wattage required to power the calculated number of cNTP-H₂O unit-cells and that the area of a 1 KW panel is 5.56 m². It is noteworthy that, in the case of installed solar panel operation, only 600 h are dedicated to power the cNTP-H₂O modules for a crop-growing season; the electricity generated in the rest of time can be sold to the grid. Still, skilled artisans will appreciate that other testing configurations and tests could yield other results.

Moreover, there could be potential to improve the performance of the cNTP-H₂O system through systematic optimization. One challenge arises from balancing minimizing the energy cost and maximizing the production rate, which can be a complex function of many factors including the plasma discharge type, the reactor geometry/configuration, the discharge operating parameters, and the presence of catalysts. Two targets that could be potentially achieved after the optimization for practical implementation are also listed in in the table of FIG. 5. Target 1 has a high optimized production rate, and Target 2 has a high optimized energy efficiency. If one of the targets is achieved, solar panels with a surface area of only about 1% of a land area will produce sufficient N-fertilizer for the land. Although the specific energy cost is still higher than that of the HB process, they are potentially viable at the farm site without the emissions and distribution costs associated with the HB process.

Moreover, hydrogen is the limiting reactant in the reduction pathway to make ammonium. This limiting reactant could be supplemented by H₂ gas or ethanol, and potentially by methane, which can be generated at the farm site via anaerobic digestion; however, the use of an extra hydrogen source or enriched N₂ or O₂ input will inevitably increase the cost for the production of the N-fertilizer.

Compared to the reduction pathway for making ammonium, the oxidation pathway to produce an aqueous N-fertilizer rich in nitrate from air and water can be advantageous; the key is to minimize the energy cost, and the content of nitrite to avoid toxicity to plants.

Using air as a feed gas to the cNTP-H₂O system, the fixed N in the product is dominantly in the form of nitrate, with less than 10 ppm of nitrite in all the cases listed in the table of FIG. 5, which can be directly utilized by plants. The nitrate concentration reached an unprecedented 380 ppm (Entry G in Table 1), ideal for fertigation.

It appeared that the metal material of the electrode that was in contact with reactants affected the performance. Therefore, catalysts can be added onto the electrode (e.g., coating/embedding catalysts onto the electrode), per embodiments, which may potentially improve the reaction kinetics and product yield.

With the non-equilibrium DBD plasma, the cNTP-H₂O system runs at non-equilibrium steady states; thus, the NTP thermodynamics and kinetics, transport processes, and chemical reaction kinetics all influence the production rate and product composition. Therefore, it is possible, based on the cNTP-H₂O platform, to further improve the production rate and specific electric energy consumption through the optimization of the process parameters and configurations.

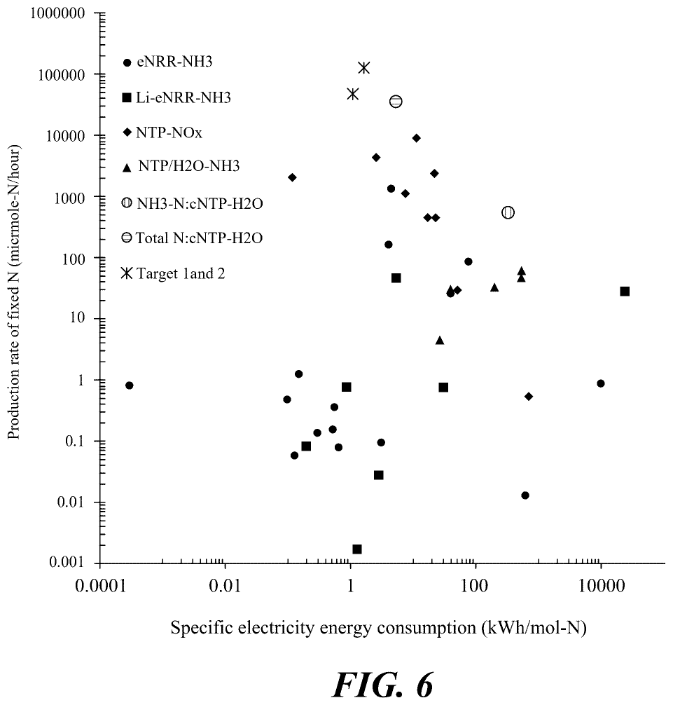

The significance of the results of the table of FIG. 5 can be revealed by benchmarking against published data, as shown in FIG. 6. Because there are different technologies using different feedstocks for nitrogen fixation (e.g., air, N₂, or artificially mixed N₂/O₂ with various ratios as the nitrogen source; and pure H₂ or water as the hydrogen source), preventing straightforward and fair comparisons, the benchmark is against four categories of promising technologies: (1) the electrocatalytic nitrogen reduction of N₂ to NH₃ (eNRR-NH₃), (2) the lithium-mediated electrocatalytic nitrogen reduction of N₂ to NH₃ (Li-eNRR-NH₃), (3) the plasma-driven NOₓ production (NTP-NOₓ), and (4) the plasma-driven NH₃ production from N₂ and water (NTP/H₂O-NH₃).

It should be pointed out that: (1) although the research effort worldwide focuses on reducing the specific energy consumption to achieve Haber-Bosch parity, both a high production rate and low specific energy consumption are required for practical implementation; (2) the logarithmic scale was used for the plot in FIG. 6 in order to capture the large variation in both the production rate and specific energy consumption reported in the literature; (3) except for the NTP-NOₓ category, most other technologies require N₂ gas instead of air as feedstock, potentially increasing the production cost; and, (4) even in the NTP-NOₓ category, the artificial mixture of N₂/O₂ with various ratios, instead of air, were commonly used to improve the NOₓ yield, and the reported yields were based on the measurement of the produced NOₓ gas, not ready to be used as N-fertilizer. Nonetheless, FIG. 6 provides an overview of the suitable status of the cNTP-H₂O system.

For the eNRR-NH₃ and Li-eNRR-NH₃ technologies to make ammonia, although some achieved a very low specific energy consumption, the production rates were too low for practical applications; the only promising one in the eNRR-NH₃ category used a hybrid method, in which NTP was first used to produce NOₓ, then the NOₓ was fed to an eNRR cell to make ammonia. Furthermore, a low system stability, the requirement for expensive ultra-dry and oxygen-free organic solvents, or the demand for pure nitrogen and hydrogen feedstocks, and platinum and lithium metal, result in low levels of technology readiness.

Generally, the NTP-NOₓ technologies have a higher production rate and moderate specific energy consumption, but most of these studies reported NO as the major product. Although a recent study in this category claimed a record-low specific energy consumption of 0.42 MJ per mol of fixed N (mainly NO) by using a pulsed plasma jet, the production rate is very low (˜480 μg-N/min).

Comparing the cNTP-H₂O result (Entry C in the table of FIG. 5) with those reported using NTP/H₂O-NH₃ technologies and N₂ gas as the feed for ammonia production, a much higher production rate was achieved using the cNTP-H₂O system, although the specific energy consumption is at the higher end of this category (but it is at the lower end considering the total fixed N). In terms of the total fixed N using air as the feed, the highest production rate was achieved compared with others in the category of NTP-NOₓ, and the specific energy consumption is at the lower end (Entry G in the table of FIG. 5). Suitable, the product of the cNTP-H₂O system is an aqueous mixture of nitrate and ammonium, which can be directly applied to plants.

Another suitable consideration in the development of the cNTP-H₂O system is practicality. Although the concentration of the fixed N in the aqueous N-fertilizer product (Entry G in the table of FIG. 5) is about 87 mg-N/L, mainly in the form of NO₃⁻, the pH is nearly neutral, which can be directly applied to plants without neutralization. This is because, it is currently believed, tap water has a buffering effect due to its carbonate hardness (KH) and general hardness (GH). Especially, the GH measures the concentration of calcium, magnesium, and other mineral ions present in the water, ranging from 10 to over 300 mg/L depending on the locations. In fact, nitric acid is used to dissolve the mineral deposition in irrigation systems, and calcium/magnesium nitrates are suitable fertilizers. Further, the pH of the aqueous N-fertilizer could be tuned by adjusting the process parameters of the cNTP-H₂O system according to specific applications, e.g., for citrus trees that prefer slightly acidic soil, or for alkaline soil.

In summary, the following observations and inferences can be made based on the test results:
i) The design and construction of this cNTP-H₂O system intensifies the interfacial reactions between water and NTP and enhances mass transfer to continuously produce a liquid N-fertilizer.
ii) Although the oxidation pathway is thermodynamically favored, there exist chemical pathways to simultaneously produce both ammonium (reduction pathway) and nitrate (oxidation pathway) from water and air using our cNTP-H₂O system. The composition of fixed nitrogen products could be potentially tuned by changing process parameters and configuration of the cNTP-H₂O system.
iii) Hydrogen is the limiting reactant in the reduction pathway to make ammonium. This limiting reactant could be supplemented by H₂ gas or ethanol, and potentially by methane, which can be generated at farm site via anaerobic digestion.
iv) Using air as feed gas, the fixed N is dominantly in the form of nitrate (with less than 2% nitrite in most cases), which can be directly utilized by plants.
v) It appeared that the metal material of the HV electrode that was in contact with reactants affected the performance. Therefore, catalysts can be added onto the HV electrode, per embodiments (e.g. coating/embedding catalysts onto the HV electrode), which may potentially change the reaction kinetics and product yield.
vi) With the non-equilibrium DBD plasma, the cNTP-H₂O system runs at non-equilibrium steady states, thus that the NTP thermodynamics and kinetics, transport processes, and chemical reaction kinetics all can influence the production rate and product composition. Therefore, it is possible, based on the cNTP-H₂O platform, to further improve production rate and specific electrical energy consumption through the optimization of process parameters and reactor geometry/configurations.

Moreover, analyses of other possible chemicals in our liquid fertilizer product, such as H₂O₂, dissolved O₃, and peroxynitrite, which are potentially beneficial to soil health and plant growth, and the sanitary effect of our cNTP-H₂O process on wastewater, are subjects to further studies.

The NTP-produced N-fertilizer can be combined with animal waste management to treat animal manure, resulting in antimicrobial effects and a higher N content compared to untreated manure, and reducing ammonia and methane emissions.

In general, while a multitude of embodiments have been depicted and described with a multitude of components and steps in each embodiment, in alternative embodiments the components and steps of various embodiments could be intermixed, combined, and/or exchanged for one another. In other words, components described in connection with a particular embodiment are not necessarily exclusive to that particular embodiment.

As used herein, the terms “general” and “generally” and “substantially” are intended to account for the inherent degree of variance and imprecision that is often attributed to, and often accompanies, any design and manufacturing process, including engineering tolerances—and without deviation from the relevant functionality and intended outcome—such that mathematical precision and exactitude is not implied and, in some instances, is not possible. In other instances, the terms “general” and “generally” and “substantially” are intended to represent the inherent degree of uncertainty that is often attributed to any quantitative comparison, value, and measurement calculation, or other representation.

It is to be understood that the foregoing is a description of one or more aspects of the disclosure. The disclosure is not limited to the particular embodiment(s) disclosed herein, but rather is defined solely by the claims below. Furthermore, the statements contained in the foregoing description relate to particular embodiments and are not to be construed as limitations on the scope of the disclosure or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

Those of skill in the art will understand that modifications (additions and/or removals) of various components of the substances, formulations, apparatuses, methods, systems, and embodiments described herein may be made without departing from the full scope and spirit of the present disclosure, which encompass such modifications and any and all equivalents thereof.

What is claimed is:

1. A non-thermal plasma reaction assembly for continuous aqueous nitrogen-based fertilizer production, the assembly comprising:
a coaxial dielectric barrier discharge reactor, comprising:
a tube housing having at least one inlet and at least one outlet;
a first plasma discharge zone residing within an interior of said tube housing and adjacent said at least one inlet, said first plasma discharge zone having a first high-voltage electrode situated thereat;
a second plasma discharge zone residing within said interior of said tube housing and downstream of said first plasma discharge zone and upstream of said at least one outlet, said second plasma discharge zone having a second high-voltage electrode situated thereat; and
a ground electrode situated at an exterior of said tube housing;
wherein a first electric field is generated at said first plasma discharge zone and a second electric field is generated at said second plasma discharge zone.

2. The non-thermal plasma reaction assembly as set forth in claim 1, wherein said at least one inlet comprises a first inlet receiving atmospheric air or nitrogen gas and a second inlet receiving water,

3. The non-thermal plasma reaction assembly as set forth in claim 1, wherein said first high-voltage electrode has a cylindrical shape with exterior grooves and is composed of an aluminum material.

4. The non-thermal plasma reaction assembly as set forth in claim 1, wherein said second high-voltage electrode has an auger shape and is composed of an aluminum material or a stainless-steel material.

5. The non-thermal plasma reaction assembly as set forth in claim 1, further comprising an elongated rod composed of a metal material extending through said first high-voltage electrode and extending through said second high-voltage electrode.

6. The non-thermal plasma reaction assembly as set forth in claim 1, wherein a first discharge gap is defined between said first high-voltage electrode and said ground electrode, and a second discharge gap is defined between said second high-voltage electrode and said ground electrode, said first discharge gap having a dimension that is less than a dimension of said second discharge gap or said first discharge gap having a dimension that is greater than a dimension of said second discharge gap.

7. The non-thermal plasma reaction assembly as set forth in claim 1, further comprising a second coaxial dielectric barrier discharge reactor located upstream of said coaxial dielectric barrier discharge reactor, said second coaxial dielectric barrier discharge reactor has an inlet that receives atmospheric air or nitrogen gas and has an outlet that fluidly communicates with said at least one inlet of said tube housing of said coaxial dielectric barrier discharge reactor.

8. The non-thermal plasma reaction assembly as set forth in claim 7, wherein said second coaxial dielectric barrier discharge reactor comprises a second tube housing, a high-voltage rod electrode extending through an interior of said second tube housing, a second ground electrode situated at an exterior of said second tube housing, and a plurality of beads residing within said interior of said second tube housing, said plurality of beads are composed of a dielectric material, are composed of a catalyst material, or some of said plurality of beads are composed of a dielectric material and another some of said plurality of beads are composed of a catalyst material.

9. The non-thermal plasma reaction assembly as set forth in claim 1, further comprising a second coaxial dielectric barrier discharge reactor having an inlet that receives a gaseous resultant from said at least one outlet of said tube housing of said coaxial dielectric barrier discharge reactor.

10. The non-thermal plasma reaction assembly as set forth in claim 9, wherein said second coaxial dielectric barrier discharge reactor comprises a second tube housing, a high-voltage rod electrode extending through an interior of said second tube housing, a second ground electrode situated at an exterior of said second tube housing, and a plurality of beads residing within said interior of said second tube housing, said plurality of beads are composed of a dielectric material, are composed of a catalyst material, or some of said plurality of beads are composed of a dielectric material and another some of said plurality of beads are composed of a catalyst material.

11. The non-thermal plasma reaction assembly as set forth in claim 10, wherein at least some of said plurality of beads comprise a manganese oxide compound.

12. The non-thermal plasma reaction assembly as set forth in claim 1, further comprising:
a second coaxial dielectric barrier discharge reactor located upstream of said coaxial dielectric barrier discharge reactor, said second coaxial dielectric barrier discharge reactor has an inlet that receives atmospheric air or nitrogen gas (N₂) and has an outlet that fluidly communicates with said at least one inlet of said tube housing of said coaxial dielectric barrier discharge reactor; and
a third coaxial dielectric barrier discharge reactor having an inlet that receives a gaseous resultant from said at least one outlet of said tube housing of said coaxial dielectric barrier discharge reactor.

13. A method of continuously producing aqueous nitrogen-based fertilizer via a non-thermal plasma reaction, the method comprising:
inputting atmospheric air or nitrogen gas and water to a first plasma discharge zone, said first plasma discharge zone having a first high-voltage electrode;
conveying resultant fluid-flow from said first plasma discharge zone to a second plasma discharge zone, said second plasma discharge zone having a second high-voltage electrode; and
generating a first electric field at said first plasma discharge zone and a second electric field at said second plasma discharge zone.

14. The method of continuously producing aqueous nitrogen-based fertilizer via the non-thermal plasma reaction as set forth in claim 13, wherein said first plasma discharge zone and said second plasma discharge zone reside within a tube housing, and a ground electrode is situated at an exterior of said tube housing.

15. The method of continuously producing aqueous nitrogen-based fertilizer via the non-thermal plasma reaction as set forth in claim 14, wherein said first high-voltage electrode has a cylindrical shape with exterior grooves and is composed of a metal material, said second high-voltage electrode has an auger shape and is composed of a metal material, and further comprising an elongated rod composed of metal material and spanning through said first plasma discharge zone and spanning through said second plasma discharge zone.

16. The method of continuously producing aqueous nitrogen-based fertilizer via the non-thermal plasma reaction as set forth in claim 13, wherein said first electric field exhibits a magnitude that is greater in value than a magnitude of said second electric field, or wherein said first electric field exhibits a magnitude that is lesser in value than a magnitude of said second electric field.

17. The method of continuously producing aqueous nitrogen-based fertilizer via the non-thermal plasma reaction as set forth in claim 13, the method further comprising:
inputting atmospheric air or nitrogen gas to a third plasma discharge zone situated upstream of said first plasma discharge zone and situated upstream of said second plasma discharge zone, said third plasma discharge zone having a high-voltage rod electrode and a plurality of beads; and
conveying resultant fluid-flow from said third plasma discharge zone to said first plasma discharge zone.

18. The method of continuously producing aqueous nitrogen-based fertilizer via the non-thermal plasma reaction as set forth in claim 17, the method further comprising conveying resultant fluid-flow from said second plasma discharge zone to fourth plasma discharge zone situated downstream of said second plasma discharge zone, said fourth plasma discharge zone having a high-voltage rod electrode and a plurality of beads.

19. A non-thermal plasma reaction assembly for continuous aqueous nitrogen-based fertilizer production, the assembly comprising:
a coaxial dielectric barrier discharge reactor, comprising:
a tube housing;
a first plasma discharge zone residing within an interior of said tube housing, said first plasma discharge zone having a first high-voltage electrode situated thereat, said first high-voltage electrode having a cylindrical shape with exterior grooves;
a second plasma discharge zone residing within said interior of said tube housing and downstream of said first plasma discharge zone, said second plasma discharge zone having a second high-voltage electrode situated thereat, said second high-voltage electrode having an auger shape;
an elongated rod extending through said first high-voltage electrode and extending through said second high-voltage electrode; and
a ground electrode situated at an exterior of said tube housing;
wherein a first discharge gap is defined between said first high-voltage electrode and said ground electrode, and a second discharge gap is defined between said second high-voltage electrode and said ground electrode, and wherein a first electric field is generated at said first discharge gap and a second electric field is generated at said second discharge gap.

20. The non-thermal plasma reaction assembly as set forth in claim 19, further comprising:
a second coaxial dielectric barrier discharge reactor located upstream of said coaxial dielectric barrier discharge reactor, said second coaxial dielectric barrier discharge reactor having an inlet that receives atmospheric air or nitrogen gas (N₂) and having an outlet that fluidly communicates with at least one inlet of said tube housing of said coaxial dielectric barrier discharge reactor; and
a third coaxial dielectric barrier discharge reactor having an inlet that receives a gaseous resultant from at least one outlet of said tube housing of said coaxial dielectric barrier discharge reactor.
